(19) United States
(12) Patent Application Publication
(10) Pub. No.: US 2026/0328152 A1
(43) Pub. Date: Oct. 22, 2026

(54) Internal Combustion Engine Control Device and Internal Combustion Engine Control Method

(71) Applicant: Hitachi Astemo, Ltd., Hitachinaka-shi, Ibaraki (JP)

(72) Inventors: Kenta MITSUFUJI, Chiyoda-ku, Tokyo (JP); Fuminori SATO, Hitachinaka-shi, Ibaraki (JP); Shinji YOKOYAMA, Hitachinaka-shi, Ibaraki (JP); Hiroki IZUMI, Hitachinaka-shi, Ibaraki (JP); Tomoyuki HOSAKA, Chiyoda-ku, Tokyo (JP)

(21) Appl. No.: 19/110,608

(22) PCT Filed: Sep. 29, 2023
(86) PCT No.: PCT/JP2023/035583

§ 371 Date: Mar. 11, 2025

(30) Foreign Application Priority Data
Oct. 28, 2022 (JP) 2022-172949

(51) Int. Cl. F02D 41/14; F02D 41/00; F02D 41/38; F02P 5/15

(52) U.S. Cl. CPC F02D 41/1454; F02D 41/0002; F02D 41/38; F02P 5/1502; F02D 2200/0414; F02D 2200/06; F02D 2200/703

(57) ABSTRACT

Provided is an internal combustion engine control device which controls an internal combustion engine including a fuel injection device that injects fuel, wherein the internal combustion engine control device includes: a combustion speed detection unit which detects a combustion speed in a cylinder; an unburned fuel level estimation unit which uses the combustion speed to estimate the level of the unburned fuel in the cylinder; an allowable value setting unit which sets an allowable value of the level of the unburned fuel; and an unburned fuel level adjustment unit which controls the internal combustion engine to make the level of the unburned fuel estimated by the unburned fuel level estimation unit, be equal to or smaller than the allowable value.

### TECHNICAL FIELD

The present invention relates to an internal combustion engine control device and an internal combustion engine control method for controlling internal combustion engines such as gasoline engines.

### BACKGROUND ART

Recently, as the development of environmentally friendly engines progresses, there has been an issue of reducing emissions of PN (Particulate Number) and THC (Total Hydro Carbon) generated when an engine starts or operates at low temperatures. Possible sources of these emissions include adhered fuel and fuel droplets generated inside the engine cylinders. These are generated when liquid fuel is introduced into the cylinder and remains there without evaporating, and are easily generated particularly when the engine starts or operates in a low-temperature environment.

Several techniques have been proposed to predict the amount of adhered fuel generated to reduce the generation of the above-described substances.

### CITATION LIST

### Patent Literature

Patent Literature 1: Japanese Unexamined Patent Application Publication No. 2005-315099
Patent Literature 2: Japanese Unexamined Patent Application Publication No. 2007-146777

### SUMMARY OF INVENTION

### Technical Problem

The technologies described in Patent Literatures 1 and 2 estimate the amount of the adhered fuel using complex calculations based on engine operating conditions and estimated cylinder wall temperatures, and also use complex calculations to determine the achieved distance of a fuel spray and to calculate the ratio of fuel mass and the ratio of unburned fuel separately. This makes it difficult to estimate the amount of the adhered fuel in real time during the operations of an actual vehicle. Furthermore, these techniques can only estimate the adhered fuel on the cylinder's inner wall and do not consider the fuel droplets floating inside the cylinder.

According to the above-described situation, there was a demand for a method capable of more easily estimating the fuel that did not contribute to the combustion using less input information.

### Solution to Problem

To solve the above-described issue, an internal combustion engine control device according to one aspect of the present invention controls an internal combustion engine having a fuel injection device to inject fuel and includes: a combustion speed detection unit to detect the combustion speed in a cylinder; an unburned fuel level estimation unit to estimate a level of unburned fuel in the cylinder using the combustion speed; an allowable value setting unit to set an allowable value for the level of the unburned fuel based on an operating condition or an actual injection quantity; and an unburned fuel level adjustment unit to control the internal combustion engine so that the level of the unburned fuel estimated by the unburned fuel level estimation unit becomes lower than or equal to the allowable value.

### Advantageous Effects of Invention

According to at least one aspect of the present invention, it is possible to more easily and accurately estimate the level of the unburned fuel by using less input information and to provide control over an internal combustion engine based on the estimated level of the unburned fuel.

Objects, configurations, and effects other than the above will be apparent from the description of the following embodiments.

### BRIEF DESCRIPTION OF DRAWINGS

FIG. 1 is a schematic cross-sectional view illustrating an internal combustion engine.

FIG. 2 is a diagram illustrating the hardware configuration of an internal combustion engine control device.

FIG. 3 is a diagram illustrating the state of fuel sprayed in an internal combustion engine.

FIG. 4 is a diagram illustrating the relationship between a combustion speed and the amount of the unburned fuel and the relationship between the amount of the unburned fuel and the air-fuel ratio.

FIG. 5 is a block diagram illustrating the configuration and input data of the internal combustion engine control device according to a first embodiment of the present invention.

FIG. 6 is a diagram illustrating the relationship between a combustion speed and the level of the unburned fuel according to the first embodiment of the present invention.

FIG. 7 is a block diagram illustrating the configuration and input data of the internal combustion engine control device according to a second embodiment of the present invention.

FIG. 8 is a diagram illustrating the relationship between a combustion speed and the level of the unburned fuel before and after correction according to a second embodiment of the present invention.

FIG. 9 is a block diagram illustrating the configuration and input data of the internal combustion engine control device according to a third embodiment of the present invention.

FIG. 10 is a diagram illustrating the relationship among a crank angle, a fuel injection signal, and the amount of the unburned fuel in a first control example according to a fourth embodiment of the present invention.

FIG. 11 is a diagram illustrating the relationship among a crank angle, a fuel injection signal, and the amount of the unburned fuel during multistage injection in the first control example according to the fourth embodiment of the present invention.

FIG. 12 is a diagram illustrating the relationship between the fuel pressure and the amount of the unburned fuel in a second control example according to the fourth embodiment of the present invention.

FIG. 13 is a diagram illustrating the relationship among a crank angle, a fuel injection signal, and the amount of the unburned fuel in a third control example according to a fourth embodiment of the present invention.

FIG. 14 is a diagram illustrating the relationship among a crank angle, a fuel injection signal, the amount of the unburned fuel, and the ignition time during multistage injection in the third control example according to the fourth embodiment of the present invention.

FIG. 15 is a diagram illustrating the relationship between a crank angle and an ignition signal and between the level of the unburned fuel and the number of pre-ignitions in a fourth control example according to the fourth embodiment of the present invention.

### DESCRIPTION OF EMBODIMENTS

By referencing the attached drawings, the description below explains examples of modes (hereinafter referred to as “embodiments”) for embodying the present invention. The same reference numerals are given to the same components or components having substantially the same functions in the present description and the attached drawings and a duplicated description is omitted for simplicity.

### First Embodiment

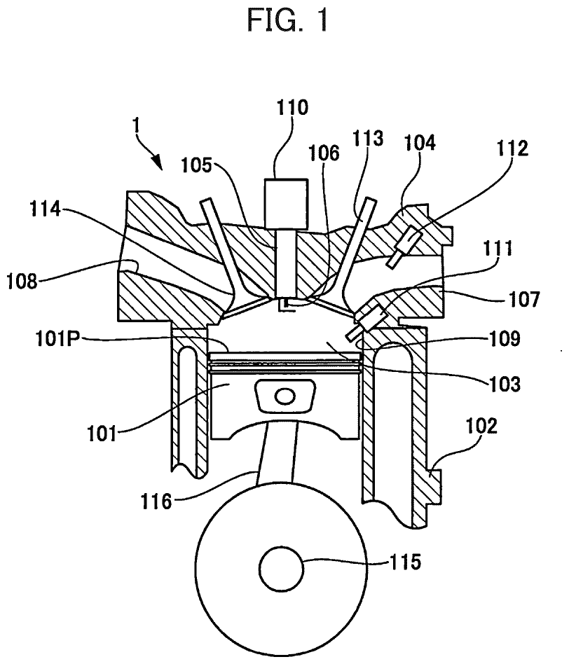

By referencing FIG. 1, the description below explains an example of the internal combustion engine.

FIG. 1 is a schematic cross-sectional view illustrating an internal combustion engine. An internal combustion engine 1 illustrated in FIG. 1 includes a piston 101, a cylinder 102, and a cylinder head 104. The cylinder head 104 forms a combustion chamber 103 composed of a crest surface 101P of the piston 101 and an inner wall 109 of the cylinder 102. An injector for fuel injection (fuel injection device) includes at least either or both of a direct injection injector 111 and a port injection injector 112. The present embodiment explains examples in which the present invention is applied to a gasoline engine as the internal combustion engine 1.

A spark plug 105 is configured directly above the combustion chamber 103 and includes an electrode 106 to ignite the mixture. During the intake stroke, air flows into the combustion chamber 103 communicated with a main combustion chamber through an intake port 107 whose intake valve 113 is opened. Fuel is sprayed, in the form of mist, by either or both of the direct injection injector 111 and a port injection injector 112 and is thereby supplied to the combustion chamber 103. The fuel vaporizes in the combustion chamber 103 and mixes with the intake air to generate an air-fuel mixture. Then, the piston 101 compresses the air-fuel mixture and a main ignition signal is transmitted to an ignition coil 110 at the appropriate timing. The spark plug 105 ignites the mixture in the combustion chamber 103 to burn the mixture in the combustion chamber 103. Consequently, the pressure in the combustion chamber 103 increases to push the piston 101 down, allowing a connecting rod 116 to rotate a crankshaft 115. The crankshaft 115 rotates to supply power to the internal combustion engine 1. An exhaust valve 114 opens to discharge the exhaust gas after combustion in the combustion chamber 103 from an exhaust port 108 to an exhaust pipe.

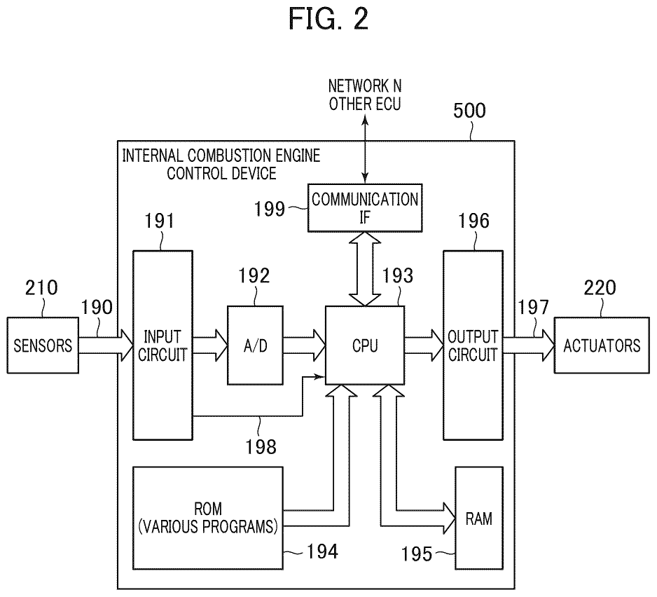

By referencing FIG. 2, the description below explains the hardware configuration of an internal combustion engine control device 500.

FIG. 2 is a block diagram illustrating the hardware configuration of an internal combustion engine control device 500.

As illustrated in FIG. 2, the internal combustion engine control device 500 includes an input circuit 191, an A/D conversion unit 192, a central processing unit (CPU) 193, read-only memory (ROM) 194, random access memory (RAM) 195, an output circuit 196, and a communication IF 199.

The CPU 193 executes a program stored in the ROM 194 (an example of a storage unit) and loaded into the RAM 195, thereby implementing functions according to the embodiments of the present invention. The CPU 193 is an example of the control device. The CPU 193 may be replaced by other processing devices such as a micro-processing unit (MPU).

The input circuit 191 is supplied with a signal output from sensors 210 as an input signal 190. For example, the sensors 210 include an intake flow sensor, a throttle sensor, a water temperature sensor, a crank angle sensor, an intake cam angle sensor, and an exhaust cam angle sensor.

When the input signal 190 is an analog signal, the input circuit 191 removes noise components from the input signal 190 and outputs the noise-removed signal to the A/D conversion unit 192.

The A/D conversion unit 192 converts an analog signal into a digital signal and outputs it to the CPU 193. The CPU 193 is supplied with the digital signal output from the A/D conversion unit 192 and executes a control logic (program) stored in a storage medium such as the ROM 194 to perform various calculations and controls.

The RAM 195 temporarily stores the calculation results of the CPU 193 and the conversion results of the A/D conversion unit 192. According to the present embodiment, the ROM 194 may use non-volatile memory such as EEPROM (electrically erasable and programmable read-only memory) whose contents can be rewritten. For example, the ROM 194 or non-volatile storage (unshown) may store a program that describes algorithms to realize the functions according to the embodiments of the present invention. For example, the unshown non-volatile storage stores multiple data acquired from the sensors 210 and map information corresponding to the unburned fuel curves described later. This non-volatile storage may be a removable storage medium such as a cassette-type SSD (Solid State Drive) used for the internal combustion engine control device 500.

The calculation results of the CPU 193 are output as a control signal 197 from the output circuit 196 and are used to control actuators 220 to as control targets. For example, the control targets include an intake valve drive device, an exhaust valve drive device, an injector, a spark plug, a steering device, a brake device, and a power conversion circuit.

When the input signal 190 is a digital signal, the input signal 190 is transmitted directly to the CPU 193 from the input circuit 191 via a signal line 198 so that the CPU 193 performs the necessary calculations and controls, for example.

The communication IF 199 is configured by a communication device that controls communication with other devices, for example. For example, the communication IF 199 is a communication device that communicates with a wide area network N (such as the Internet) or an ECU such as a master ECU (unshown) or sensors in a vehicle via a CAN (Controller Area Network).

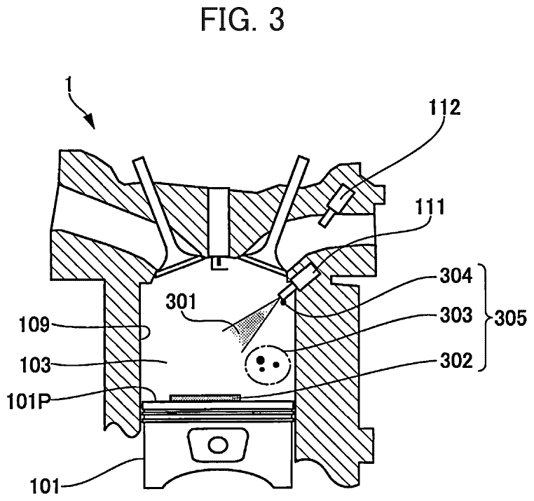

FIG. 3 is a diagram illustrating the state of fuel sprayed in the internal combustion engine 1.

Normally, liquid fuel injected from an injector may adhere to the opposing wall in liquid form unchanged. For example, as illustrated in FIG. 3, when the direct injection injector 111 injects a fuel spray 301 into the combustion chamber 103, a fuel liquid film 302 is formed on the crest surface 101P of the piston 101 or the inner wall 109 of the cylinder 102. Because the fuel spray 301 is injected at high speed, droplets 303 may scatter in the combustion chamber 103 due to the impact of colliding with the crest surface 101P of the piston 101 or the inner wall 109 of the cylinder 102. The fuel droplets may remain and adhere around the nozzle of the direct injection injector 111, generating tip wet 304.

When the spark plug 105 ignites the air-fuel mixture in the combustion chamber 103, the remaining fuel liquid film 302, the droplets 303, or the tip wet 304, if any, burns in liquid form. The fuel liquid film 302, the droplets 303, or the tip wet 304, remaining at the moment the flame arrives, cannot contribute to the output of the internal combustion engine 1 and diffuses and burns separately from the air-fuel mixture. As a result, PN or THC is generated. The same phenomenon occurs when the port injection injector 112 is used. Fuel such as the fuel liquid film 302, the droplets 303, and the tip wet 304 that cannot contribute to the output of the internal combustion engine 1 is collectively referred to as “unburned fuel 305.”

To reduce the unburned fuel 305, there are considered measures such as controlling shapes and lengths of the fuel spray 301 into the combustion chamber 103 and suppressing the generation of the fuel liquid film 302. Usually, the injection conditions are optimized so that the air-fuel ratio in the combustion chamber 103 of the internal combustion engine 1 satisfies a targeted value.

However, during a cold start when the outside air temperature is low, the actual air-fuel ratio deviates from the targeted air-fuel ratio due to an evaporation failure of the fuel in the combustion chamber 103. Another cold start occurs when the internal combustion engine 1 restarts after a short stop such as a temporary stop during idling. The unburned fuel usually increases at the cold start, causing problems such as not only frequent occurrence of PN or THC but also misfire due to unsuccessful combustion. At the cold start, for example, the catalyst is not yet warmed and conventional oxygen sensors or air-fuel ratio sensors are not yet activated, making it difficult to acquire accurate measurements using sensors.

Patent literature 1 introduces a technology that estimates the amount of the fuel liquid film 302 in a combustion chamber using complex equations based on engine operating conditions, fuel injection conditions, and engine water temperature, for example. To estimate the amount of the fuel liquid film 302, this technology needs to separately calculate the ratio of combustion mass and the ratio of the unburned fuel using complex equations, making it difficult to estimate the unburned fuel 305 illustrated in FIG. 3 in real time on an actual vehicle. In addition, the technology described in patent literature 1 can only estimate the amount of the fuel liquid film 302 but cannot estimate the amount of the droplets 303 or the tip wet 304. There have been considered the relationships between lengths and the amount of the fuel concerning the fuel liquid film 302 and the fuel spray 301 and inner wall temperatures of the internal combustion engine 1, but not actual combustion states, especially the relationship between the combustion speed and the unburned fuel 305. The combustion speed according to the present specification signifies the time it takes for the air-fuel mixture to ignite and burn completely or the time it takes for the air-fuel mixture to reach a specified ratio of fuel mass. The combustion speed is considered to vary with the speed at which the flame propagates through the air-fuel mixture.

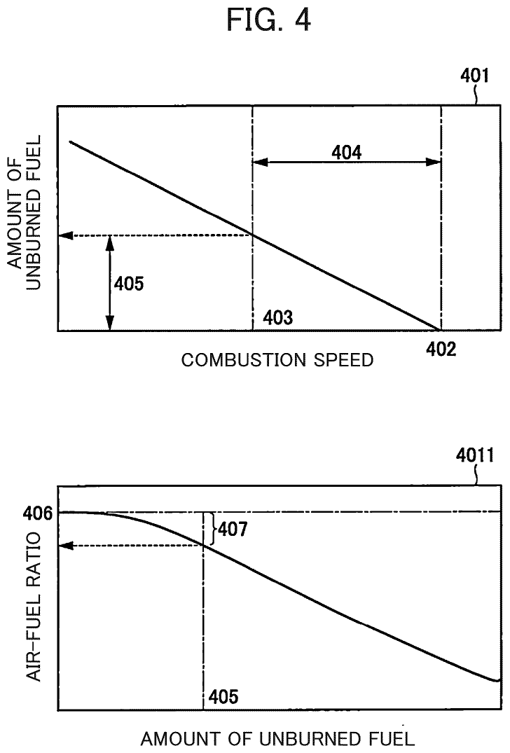

FIG. 4 is a diagram illustrating the relationship between the combustion speed and the amount of the unburned fuel and the relationship between the amount of the unburned fuel and the air-fuel ratio. Here are illustrated: relationship 401 (upper part of FIG. 4) between the combustion speed and the amount of the unburned fuel when fuel is injected into the combustion chamber 103 to achieve an ideal air-fuel ratio and burned in the combustion chamber 103; and relationship 4011 (lower part of FIG. 4) between the amount of the unburned fuel and the air-fuel ratio in the combustion chamber 103. The present invention aims at injecting fuel to meet an ideal air-fuel ratio or lower in consideration of the recent rise of environmentally friendly engines. When the targeted air-fuel ratio, the load of the internal combustion engine 1, and the ignition timing are unchanged, a difference 407 (amount of deviation) occurs between the targeted air-fuel ratio and the air-fuel ratio of the air-fuel mixture that actually burns as the amount of the unburned fuel increases as illustrated in FIG. 4. This is because the laminar-flow combustion speed of fuel varies with the air-fuel ratio.

Usually, settings such as the fuel spray in the internal combustion engine 1 are optimized so that the amount of the unburned fuel is smaller than or equal to an allowable value. However, as described above, external factors such as the outside air temperature may cause the amount of the unburned fuel to exceed an allowable value (deviate from an allowable range). The combustion speed at which fuel burns is strongly affected by the fuel components and the atmospheric temperature and pressure. It is possible to estimate the level of the unburned fuel 405 at the time of combustion, namely, the difference 407 from a reference value 406 of the air-fuel ratio if a difference 404 between a reference combustion speed 402 and an actual combustion speed 403 is found based on the targeted air-fuel ratio, the load, and the ignition timing.

For example, Japanese Unexamined Patent Application Publication No. 2021-161904 (Reference Literature 1) describes the method of detecting the combustion speeds as a method of accurately detecting the combustion phase from the ignition time by reading changes in the output from the crank angle sensor (unshown). The Ignition time signifies information on the ignition timing (such as a crank phase relative to the compression top dead center). It is possible to determine whether the combustion speed is fast or slow by checking whether the combustion phase is advanced or delayed. For example, the combustion speed can be expressed as the time from the start of combustion to the time the ratio of combustion mass 50% (MFB 50) is reached.

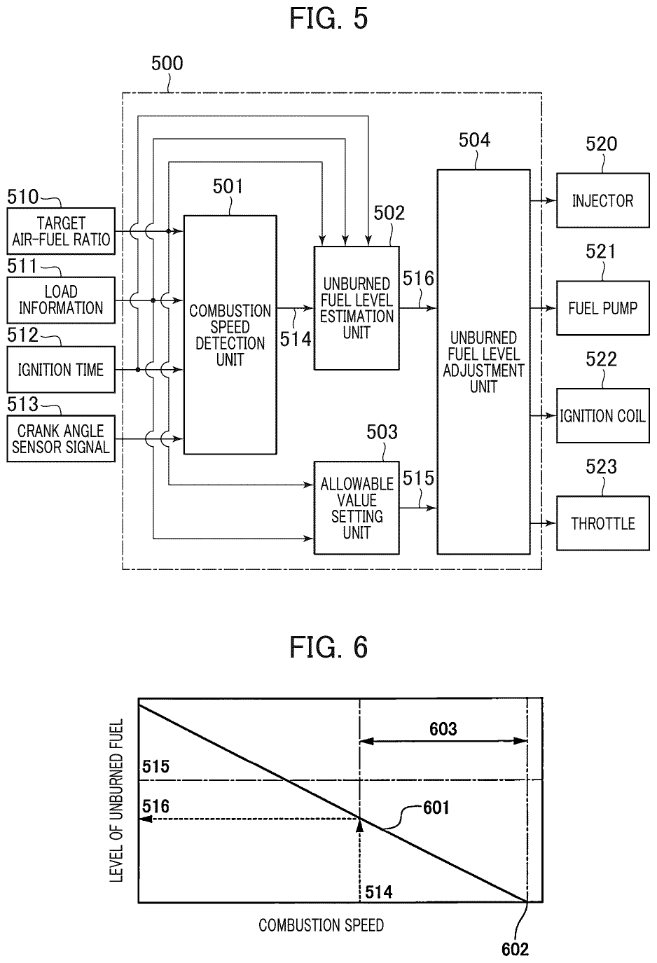

FIG. 5 is a block diagram illustrating the configuration and input data of the internal combustion engine control device 500 according to the present embodiment. The internal combustion engine control device 500 includes a combustion speed detection unit 501 to detect the combustion speed in the cylinder 102 (combustion chamber 103), an unburned fuel level estimation unit 502 to estimate the level of the unburned fuel in the cylinder 102 based on the combustion speed, an allowable value setting unit 503 to set an allowable value for the estimated level of the unburned fuel, and an unburned fuel level adjustment unit 504 to control the internal combustion engine 1 so that the estimated level of the unburned fuel is smaller than or equal to the allowable value.

The combustion speed detection unit 501 is supplied with at least such variables greatly affecting combustion speeds as the targeted air-fuel ratio (target air-fuel ratio 510), load information 511, ignition time 512, and a crank angle sensor signal 513. For example, the load information 511 includes the number of revolutions and the intake pressure of the internal combustion engine 1 (crankshaft 115). As described in Reference Literature 1 above, the combustion speed detection unit 501 observes changes in the crank angle sensor signal 513 to detect the combustion speed. The combustion speed detection unit 501 outputs a detected combustion speed 514 to the unburned fuel level estimation unit 502.

The allowable value setting unit 503 is supplied with at least the target air-fuel ratio 510 and the load information 511. The allowable value setting unit 503 sets the allowable level of the unburned fuel (allowable level of the unburned fuel 515) based on the target air-fuel ratio 510 and the load information 511 supplied as operating conditions and outputs it to the unburned fuel level adjustment unit 504. For example, the allowable level of unburned fuel 515 may be set as a percentage of the fuel injection quantity (estimated value) calculated from the target air-fuel ratio 510 and the load information 511 or as a percentage of the actual fuel injection quantity (actual measurement value). For example, the actual fuel injection quantity is an average of the fuel quantity injected from the injector 520 in an arbitrary set time range.

The allowable level of the unburned fuel 515 may include a storage unit (unshown) that stores the map information based on the results of a simulation or experiment performed in advance. For example, the storage unit may be available as cache memory, a register, or a fragment written in a computer program. For example, the map information defines the relationship among the target air-fuel ratio, the load information, and the allowable level of the unburned fuel. Calculations can be performed at high speed by storing the relationship among these items as the map information.

The unburned fuel level estimation unit 502 is supplied with at least the combustion speed 514 detected by the combustion speed detection unit 501, the target air-fuel ratio 510, the load information 511, and the ignition time 512.

As illustrated in FIG. 6, the unburned fuel level estimation unit 502 stores an unburned fuel curve 601 that shows the relationship between the combustion speed 514 and the estimated value of the level of unburned fuel 516. The unburned fuel curve 601 is set for each combination of the target air-fuel ratio 510, the load information 511, and the ignition time 512. In FIG. 6, the unburned fuel curve 601 is illustrated as a straight line but may actually be a curve.

FIG. 6 is a diagram illustrating the relationship between a combustion speed of the air-fuel mixture and the level of the unburned fuel according to the first embodiment of the present invention. The unburned fuel curve 601 is determined under a given condition of the certain target air-fuel ratio 510, the load information 511, and the ignition time 512. In this case, combustion speed 602 as a reference (reference combustion speed) may correspond to a combustion speed when the amount of the unburned fuel is 0 and a uniform air-fuel mixture is burned or may use a value acquired in advance from an experiment in a warmed-up state (condition of the fully warmed internal combustion engine 1) or a simulation based on the assumption of a warmed-up state.

For example, the unburned fuel level estimation unit 502 may include a storage unit (unshown) that stores the unburned fuel curve 601 as map information for each of the target air-fuel ratio 510, the load information 511, and the ignition time 512. For example, the storage unit may be available as cache memory, a register, or a fragment written in a computer program. The stored map information can quickly calculate the level of the unburned fuel.

The unburned fuel level estimation unit 502 estimates the level of the unburned fuel by checking the combustion speed detected by the combustion speed detection unit 501 against the ignition timing, the load on the internal combustion engine 1, and the unburned fuel curve 601 as information showing the relationship between the combustion speed previously set based on the target air-fuel ratio 510 and the level of the unburned fuel. The level of the unburned fuel 516 can be estimated by referencing the unburned fuel curve 601 from the combustion speed 514. This is comparable to finding a difference between the reference combustion speed 602 and the actual combustion speed 514. In other words, the estimated level of the unburned fuel 516 reflects this combustion speed difference 603.

The level of the unburned fuel 516 may be defined as the mass of the unburned fuel, the ratio of the unburned fuel to the injected fuel quantity, or a section in which the mass of the unburned fuel is divided into finite segments. For example, the level of the unburned fuel 516 may be divided into three segments such as “high”, “intermediate (appropriate amount) ”, and “low” or five segments such as “too high”, “slightly high”, “intermediate (appropriate amount) ”, “slightly low”, and “too low” depending on the mass of the unburned fuel. The level of the unburned fuel 516 is set in a state of including the entire fuel existing in a liquid state (comparable to the unburned fuel 305) such as the fuel liquid film 302, the droplets 303, and the tip wet 304.

The unburned fuel level adjustment unit 504 is supplied with the allowable level of the unburned fuel 515 and the level of the unburned fuel 516. When the level of the unburned fuel 516 exceeds the allowable level of the unburned fuel 515, the unburned fuel level adjustment unit 504 controls at least one of the injector 520, the fuel pump 521, the ignition coil 522 (ignition device), and a throttle 523 so that the level of the unburned fuel 516 becomes lower than or equal to the allowable level of the unburned fuel 515. This control can reduce the amount of the unburned fuel in the combustion chamber 103. The injector 520 is comparable to the direct injection injector and the port injection injector 112. The ignition coil 522 is comparable to the ignition coil 110. Generally, the internal combustion engine control device 500 receives information showing the amount of accelerator depression and the state of the internal combustion engine 1 from the sensors 210 and integrates the information to adjust the final angle of the throttle 523.

Even during cold start when the catalyst is not yet activated, the present invention can estimate the level of the unburned fuel based on the actual combustion speed 514 and the allowable level of the unburned fuel 515 as a reference set from the operating conditions (target air-fuel ratio 510 and load information 511). The present invention can be used to detect the unburned fuel during cold engine start, hitherto incapable of detection, and also after warming up.

As above, the present embodiment configures the internal combustion engine control device (internal combustion engine control device 500) that controls the internal combustion engine including a fuel injection device (injector 520) to inject fuel and includes: the combustion speed detection unit (combustion speed detection unit 501) that detects the combustion speed in the cylinder (cylinder 102) ; the unburned fuel level estimation unit (unburned fuel level estimation unit 502) that estimates the level of the unburned fuel in the cylinder using the combustion speed; the allowable value setting unit (allowable value setting unit 503) that sets the allowable value (allowable level of the unburned fuel 515) for the level of the unburned fuel based on the operating condition or the actual fuel injection quantity; and the unburned fuel level adjustment unit (unburned fuel level adjustment unit 504) that controls the internal combustion engine so that the level of the unburned fuel estimated by the unburned fuel level estimation unit becomes lower than or equal to the allowable value.

The internal combustion engine control device according to the present embodiment configured above can more easily and accurately estimate the level of the unburned fuel using less input information. The present embodiment can adjust the level of the unburned fuel to be lower than or equal to the allowable value based on the estimated level of the unburned fuel (to control the internal combustion engine).

### Second Embodiment

The second embodiment provides an example of improving the accuracy of estimating the level of the unburned fuel compared to the first embodiment.

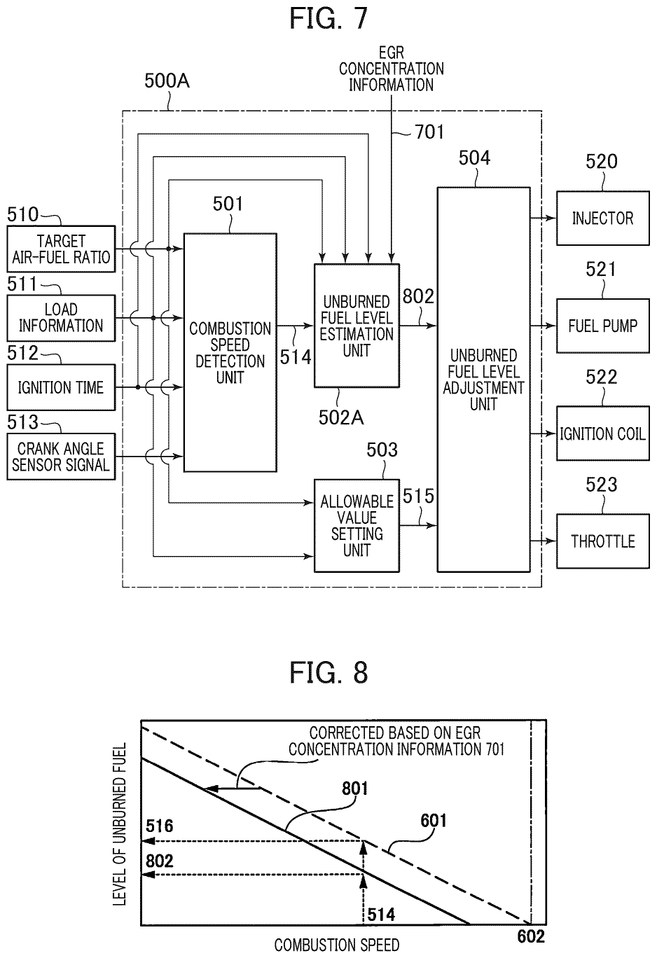

By referencing FIG. 7, the description below explains an example of the configuration of the internal combustion engine control device according to the second embodiment.

FIG. 7 is a block diagram illustrating the configuration and input data of the internal combustion engine control device 500A according to a second embodiment. An internal combustion engine control device 500A differs from the internal combustion engine control device 500 according to the first embodiment in that the unburned fuel level estimation unit 502 is replaced by an unburned fuel level estimation unit 502A. The unburned fuel level estimation unit 502A is supplied with EGR concentration information 701 of an EGR (Exhaust Gas Recirculation) system (unshown) included in the internal combustion engine 1.

When fuel burns, the combustion state is strongly affected by the fuel components and the atmospheric temperature and pressure. In addition, practically, an engine sometimes recirculates exhaust gas (inert gas) in the combustion chamber 103 to dilute and burn the air-fuel mixture and the combustion speed is affected by the concentration of recirculated exhaust gas (hereinafter also referred to as “EGR”). The EGR concentration is defined as the ratio of the amount of the exhaust gas recirculated in the cylinder 102 to the volume of the cylinder 102 during a given period.

The combustion at a high EGR concentration may decrease the accuracy of estimating the level of the unburned fuel. The unburned fuel level estimation unit 502A must be supplied with the EGR concentration information 701 so that the unburned fuel curve 601 indicated by a dashed line is corrected to an unburned fuel curve 801 indicated by a solid line as illustrated in FIG. 8. The EGR concentration may be replaced by an EGR rate. The EGR rate is defined as the ratio of the amount of recirculated exhaust gas to the intake volume of the cylinder 102.

FIG. 8 is a diagram illustrating the relationship between a combustion speed and the level of the unburned fuel before and after correction according to the present embodiment. In FIG. 8, the horizontal axis represents the combustion speed, and the vertical axis represents the level of the unburned fuel. When the unburned fuel level estimation unit 502A is not supplied with the EGR concentration information 701, the level of the unburned fuel 516 is estimated from the combustion speed 514 according to the unburned fuel curve 601. When the EGR concentration information 701 is supplied, the unburned fuel level estimation unit 502A uses the EGR concentration information 701 to correct the unburned fuel curve 601 to the unburned fuel curve 801. The unburned fuel level estimation unit 502A can estimate the level of unburned fuel 802 corrected using the EGR concentration information 701 in comparison with the level of the unburned fuel 516 without the use of the EGR concentration information 701.

As above, the present embodiment can estimate the level of the unburned fuel considering the dilution of the air-fuel mixture due to EGR by supplying the EGR concentration information 701 to the unburned fuel level estimation unit 502A. Compared to the first embodiment, the present embodiment can improve the accuracy of estimating the level of the unburned fuel.

### Third Embodiment

The third embodiment provides another example of improving the accuracy of estimating the level of the unburned fuel compared to the first embodiment.

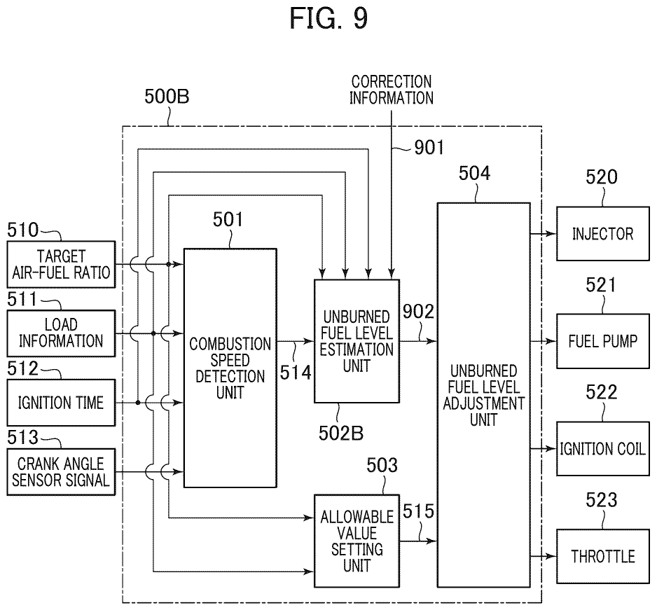

By referencing FIG. 9, the description below explains an example of the configuration of the internal combustion engine control device according to the third embodiment.

FIG. 9 is a block diagram illustrating the configuration and input data of the internal combustion engine control device 500B according to a third embodiment. An internal combustion engine control device 500B differs from the internal combustion engine control device 500 according to the first embodiment in that the unburned fuel level estimation unit 502 is replaced by an unburned fuel level estimation unit 502B. Correction information 901 is supplied to the unburned fuel level estimation unit 502B. The EGR concentration information 701 according to the second embodiment can be considered as a type of the correction information 901 according to the present embodiment.

For example, a compression ratio of the internal combustion engine 1 is expressed as the ratio between the volume of the combustion chamber 103, formed by the crest surface 101P and the inner wall 109 of the piston 101, when the crest surface 101P is positioned at the bottom dead center and the volume of the same when the crest surface 101P is positioned at the top dead center. The air introduced into the internal combustion engine 1 is compressed at the compression ratio and ignited. The temperature and the pressure of the ignited air-fuel mixture vary with the compression ratio of the internal combustion engine 1.

The combustion speed 602 as a reference differs depending on the internal combustion engine 1.

When the unburned fuel level estimation unit 502B estimates the level of the unburned fuel, the compression ratio information if available as the correction information 901 makes it possible to correct the unburned fuel curve 601 according to the compression ratio even if the shape (bore stroke) of the internal combustion engine 1 changes. Even if the internal combustion engine 1 as a target changes, the internal combustion engine control device 500B can acquire an optimal unburned fuel curve and estimate the corrected level of an unburned fuel 902. The correction information 901 may use environmental information such as the intake temperature or the outside air temperature.

The present embodiment can estimate the level of the unburned fuel considering the compression ratio or environmental information on the internal combustion engine 1 by supplying the unburned fuel level estimation unit 502B with the information such as the compression ratio, the intake temperature, or the outside air temperature concerning the internal combustion engine 1. Compared to the first embodiment, the present embodiment can improve the accuracy of estimating the level of the unburned fuel.

### Fourth Embodiment

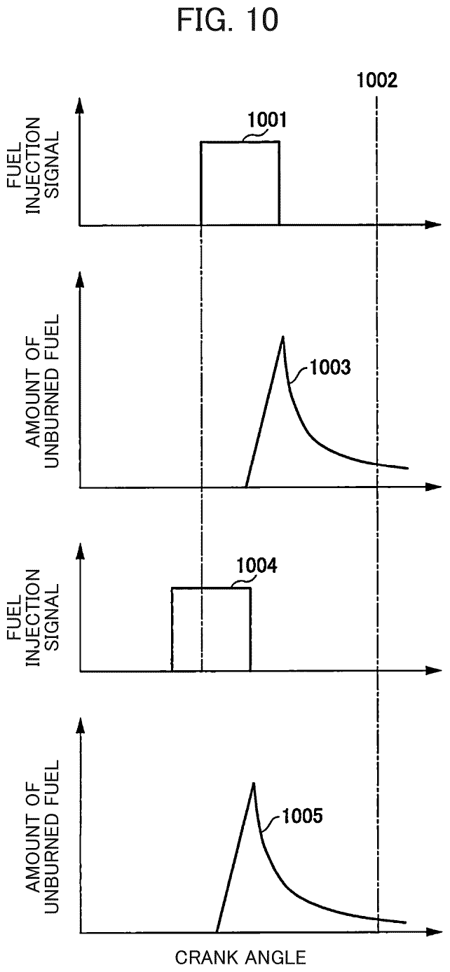

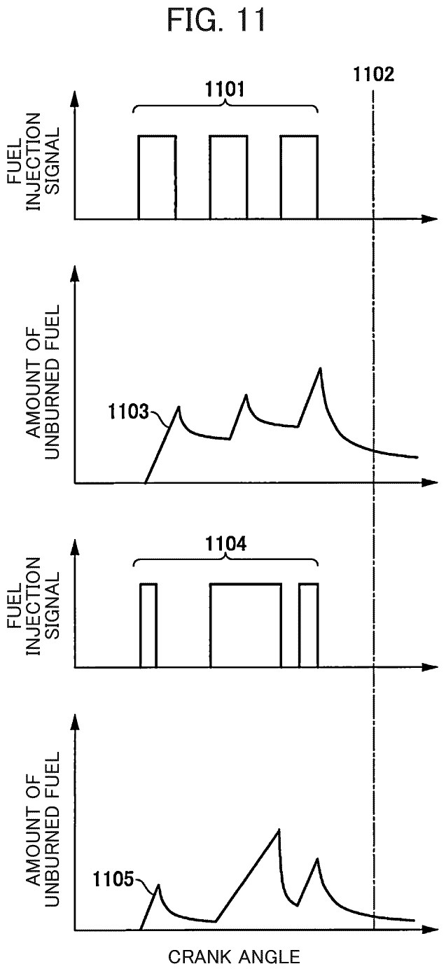

By referencing FIGS. 10 through 15, the description below explains control examples where the unburned fuel level adjustment unit 504 according to the first through third embodiments controls the amount of the unburned fuel. By referencing FIGS. 10 and 11, the description below explains a first control example where the unburned fuel level adjustment unit 504 controls the amount of the unburned fuel.

### First Control Example

FIG. 10 is a diagram illustrating the relationship among a crank angle, a fuel injection signal, and the amount of the unburned fuel in a first control example according to a fourth embodiment. In FIG. 10, the first and second graphs show the fuel injection signal and the amount of the unburned fuel before the amount of the unburned fuel is controlled, and the third and fourth graphs show the fuel injection signal and the amount of the unburned fuel after the amount of the unburned fuel is controlled.

When fuel is injected as indicated by a fuel injection signal 1001, for example, the amount of the unburned fuel transitions as indicated by the amount of an unburned fuel 1003 and is ignited at the ignition time 1002 (first and second graphs in FIG. 10). When the internal combustion engine 1 is cold, the amount of the unburned fuel at ignition may increase more than expected. This may be because of cold intake air, causing poor fuel evaporation or unsuccessful evaporation of the fuel droplets 303 generated when the fuel spray 301 collides with the wall, for example.

As a solution, the unburned fuel level adjustment unit 504 provides control to advance the fuel injection timing of the injector 520 and corrects the fuel injection signal 1001 to a fuel injection signal 1004 (third graph of FIG. 10), thereby ensuring a sufficiently long time until the fuel evaporates. It is possible to promote the evaporation of the droplets 303 and reduce the amount of the unburned fuel at the ignition time 1002 as illustrated by the amount of an unburned fuel 1005 (fourth graph of FIG. 10). In this case, however, the fuel injection may start at a position of the piston 101 closer to the top dead center and may increase the amount of the adhered fuel onto the crest surface 101P of the piston 101. As a solution, the fuel pressure may be adjusted in conjunction with the fuel injection timing. A low fuel pressure shortens the achieved distance of the fuel spray 301, making it expected to reduce the amount of the unburned fuel.

FIG. 11 is a diagram illustrating the relationship among a crank angle, a fuel injection signal, and the amount of the unburned fuel during multistage injection in the first control example according to the fourth embodiment. In recent years, there has been developed a technology that generates multiple pulse signals such as fuel injection signals 1101, and injects the fuel multiple times at the same combustion cycle to shorten the achieved distance of the fuel spray 301 and reduce the amount of adhered fuel illustrated as the amount of an unburned fuel 1103 (first and second graphs in FIG. 11). However, even this technology may not achieve the expected amount of the unburned fuel at an ignition time 1102 illustrated as the amount of the unburned fuel 1103 if the temperature of the inner wall 109 of the cylinder 102 or the intake temperature is low.

As a solution, for example, a fuel injection signal 1104 increases the fuel injection quantity of the second injection at the position where the crest surface 101P of the piston 101 is close to the bottom dead center (third graph in FIG. 11). This case reduces the fuel injection quantity of the first and third injections in which fuel is injected at the position where the crest surface 101P of the piston 101 is close to the top dead center. The amount of the fuel spray 301 reaching the crest surface 101P is reduced, making it possible to reduce the amount of the adhered fuel as illustrated by the amount of an unburned fuel 1105 (fourth graph in FIG. 11).

It may be favorable to newly perform fuel injection (such as an unshown fourth injection) during the compression stroke. In this case, there may be a possibility to increase the fuel liquid film 302 adhering to the crest surface 101P of the piston 101 and the droplets 303 to be generated, but the compression decreases and easily evaporates the fuel liquid film 302 and the droplets 303.

It may be favorable to reduce the fuel injection quantity at the beginning of the intake stroke (such as the first injection). It is possible to decrease the fuel liquid film 302 adhering to the crest surface 101P of the piston 101 and the droplets 303 to be generated and reduce the amount of the adhered fuel.

It may be favorable to control the amount of the adhered fuel by increasing or decreasing the interval between pulses of the fuel injection signal. The above-described multistage injection basically does not change the total injection quantity in one combustion cycle before and after changing the fuel injection method.

### Second Control Example

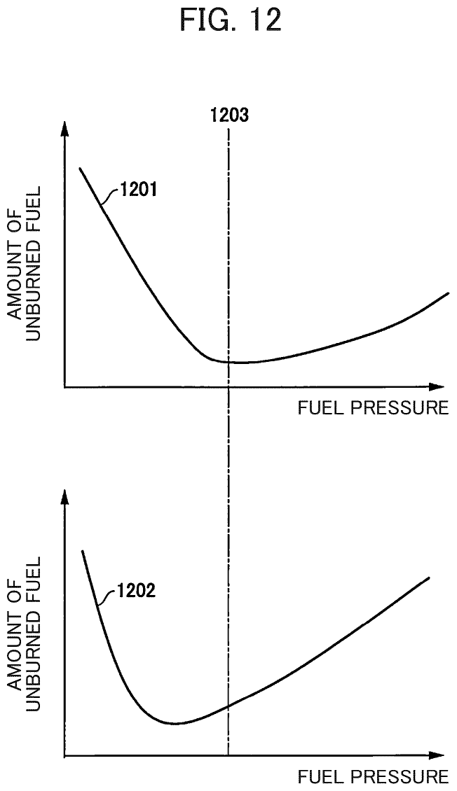

By referencing FIG. 12, the description below explains a second control example where the unburned fuel level adjustment unit 504 controls the amount of the unburned fuel.

FIG. 12 is a diagram illustrating the relationship between the fuel pressure and the amount of the unburned fuel in a second control example according to the fourth embodiment. The fuel pump 521 applies a fuel injection pressure (hereinafter referred to as “fuel pressure”) which, if increased, moreover atomizes the fuel spray 301 and the droplets 303 injected from the injector 520 and promotes the fuel evaporation. However, since the flying speed of the injected fuel spray 301 also increases, the fuel pressure and the amount of the unburned fuel maintain a relationship like a curve 1201 (upper part of FIG. 12) that increases the amount of the unburned fuel as the fuel pressure increases, depending on the positioning of the injector 520 and shapes of the combustion chamber 103.

When the wall temperature inside the combustion chamber 103 is low at the start of the internal combustion engine 1, for example, the fuel, once adhering, requires time to evaporate, possibly increasing the amount of the unburned fuel more than expected. A curve 1202 (lower part of FIG. 12) illustrates the relationship between the fuel pressure of the fuel pump 521 and the amount of the unburned fuel during cold start, showing that the characteristics of the amount of the unburned fuel during cold start differ from those during warming up. An example of cold start illustrated in the lower part of FIG. 12 shows that an increase in the fuel pressure increases the amount of the unburned fuel more than warming up and the amount of the unburned fuel tends to increase from a fuel pressure lower than the fuel pressure 1203 that minimizes the amount of the unburned fuel during warming up.

As a solution, the unburned fuel level adjustment unit 504 provides control to vary the fuel pressure of the fuel pump 521 during cold start and warming up, enabling the amount of the unburned fuel to approximate a targeted value.

### Third Control Example

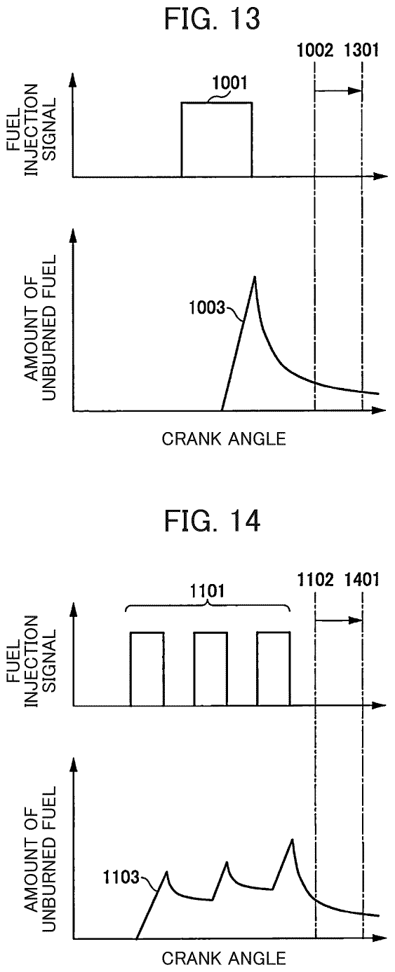

By referencing FIGS. 13 and 14, the description below explains a third control example where the unburned fuel level adjustment unit 504 controls the amount of the unburned fuel.

FIG. 13 is a diagram illustrating the relationship among a crank angle, a fuel injection signal, and the amount of the unburned fuel in a third control example according to a fourth embodiment. The upper and lower graphs in FIG. 13 are equal to the upper and lower graphs in FIG. 10.

As explained by referencing FIG. 12, the internal combustion engine 1 at cold start is considered to require a longer time to evaporate the fuel and a larger amount of the unburned fuel than normal. As a solution, the ignition time 1002 is retarded like ignition time 1301 (upper graph of FIG. 13), making it possible to ensure sufficient time for the fuel to evaporate and allow the amount of the unburned fuel to approximate a targeted value (lower graph of FIG. 13).

FIG. 14 is a diagram illustrating the relationship among a crank angle, a fuel injection signal, the amount of the unburned fuel, and the ignition time during multistage injection in the third control example according to the fourth embodiment. The upper and lower graphs in FIG. 14 are equal to the upper and lower graphs in FIG. 11.

As illustrated in FIG. 14, it may be also favorable for the multistage injection to retard the ignition time 1102 like ignition time 1401 (upper graph of FIG. 14). It is possible to ensure sufficient time for the fuel to evaporate and allow the amount of the unburned fuel to approximate a targeted value similar to the one-time fuel injection illustrated in FIG. 13 (lower graph of FIG. 14).

### Fourth Control Example

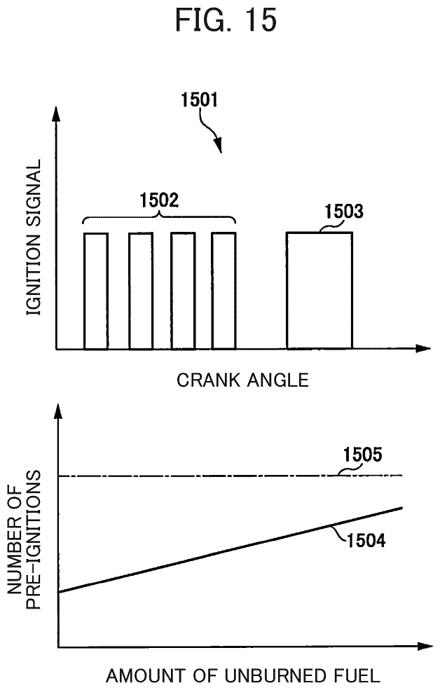

By referencing FIG. 15, the description below explains a fourth control example where the unburned fuel level adjustment unit 504 controls the amount of the unburned fuel.

FIG. 15 is a diagram illustrating the relationship between a crank angle and an ignition signal and between the level of the unburned fuel and the number of pre-ignitions in a fourth control example according to the fourth embodiment. If the amount of the unburned fuel increases too much, there is a risk of misfire during combustion. If a misfire occurs, the THC discharge increases. As a solution, it is effective to provide a pre-ignition system like an ignition signal 1501 that outputs a pre-ignition signal 1502, allowing the ignition coil 522 to previously perform multiple ignitions during the intake stroke, and then outputs a main ignition signal 1503 (upper part of FIG. 15).

For example, the number of pre-ignitions is varied according to the level of the unburned fuel based on a curve 1504 representing the number of pre-ignitions (lower part of FIG. 15) within the range of the number of pre-ignitions up to 1505 as an upper limit dependent on the performance and the electricity consumption limitation on the ignition coil 522. This makes it possible to generate the pre-ignition signal 1502 including the number of pre-ignitions optimal for reducing THC. Multiple pre-ignitions also increase the temperature of the spark plug 105, making it expected to promote the evaporation of fuel around the electrode 106 of the spark plug 105.

If the level of the unburned fuel 516 does not become lower than or equal to the allowable level of the unburned fuel 515, especially if the level of the unburned fuel 516 does not decrease, for example, it may be favorable to control the throttle 523 to reduce the amount of air supplied to the combustion chamber 103 and decrease the number of revolutions of the internal combustion engine 1. A decrease in the number of revolutions makes it possible to keep a specified amount of burnt gas in the high-temperature combustion chamber 103, completely burn HC (hydrocarbon), and reduce PN and THC.

The first through fourth control examples of the amount of the unburned fuel according to the present embodiment can be performed not only individually but also collaboratively. The multiple controls, if provided collaboratively, can eliminate the disadvantages resulting from controlling the amount of the unburned fuel and reduce the amount of the unburned fuel or the amount of generated PN and THC.

For example, as illustrated in FIG. 12, an increased fuel pressure extends the achieved distance of the fuel spray 301 and increases the amount of adhered fuel. Contrastingly, an increased fuel pressure reduces the amount of the adhered fuel because the fuel spray 301 becomes reduced in size and the droplets 303, if generated, evaporates easily. These phenomena are associated with an increase in the fuel pressure and contradict each other. Therefore, it is possible to combine controls depending on the operating conditions as needed and change the control on the amount of the unburned fuel in various ways. The description below explains combinations of two control examples.
(1) The fuel pressure is increased and the fuel injection is retarded corresponding to the extended achieved distance of the fuel spray 301 (injected after the crest surface 101P of the piston 101 lowers).
(2) Fuel is injected when the crest surface 101P of the piston 101 lowers (retarding) to shorten the time until the fuel is completely evaporated, thus retarding the ignition timing (ensuring sufficient time until evaporation).

The fourth embodiment has described the first through fourth control examples of the amount of the unburned fuel, allowing the control method to vary with the structural configuration (compression ratio) of the internal combustion engine 1.

As above, according to the present embodiment, the unburned fuel level adjustment unit 504 appropriately controls the injector 520 (fuel injection device), the fuel pump 521, the ignition coil 522 (ignition device), and the throttle 523 so that the level of the unburned fuel remains smaller than or equal to an allowable value, thereby reducing the generation of PN and THC.

In each embodiment, the amount of the unburned fuel may be controlled independently for each cylinder. In an internal combustion engine including multiple cylinders, the unburned fuel level adjustment unit 504 controls at least one of the injector 520, the fuel pump 521, the ignition coil 522 (ignition device), and the throttle 523 so that the level of the unburned fuel 516 for each cylinder becomes smaller than or equal to the allowable level of the unburned fuel 515. This makes it possible to reduce the discharge of THC and PN for the entire internal combustion engine including multiple cylinders.

In the above-described embodiments, the internal combustion engine is applied to a gasoline engine as an example and may be also applied to a gas engine or a diesel engine, for example.

The present invention is not limited to the above-described embodiments but can be embodied in various applications and modifications without departing from the spirit and scope thereof. For example, the embodiments are described in detail and specifically to easily understand the invention and are not necessarily limited to embodiments having all the components that have been described. The configuration of an embodiment can be partially replaced by the components of another embodiment. The components of an embodiment can be added to the configuration of another embodiment. The configuration of each embodiment can be partially subject to the addition, replacement, or deletion of other components.

All or part of the above-described configurations, functions, and processing units, for example, may be implemented as hardware by designing integrated circuits, for example. A processor device in the broad sense, such as an FPGA (Field Programmable Gate Array) or an ASIC (Application Specific Integrated Circuit), may be used as the hardware.

The embodiments have presented the control lines or information lines considered necessary for the description, but not all the control lines or information lines needed for a product. Practically, almost all the components may be considered mutually connected.

### LIST Of REFERENCE SIGNS

1: internal combustion engine, 101: piston, 101P: crest surface, 102: cylinder, 103: combustion chamber, 105: spark plug, 110: ignition coil, 111: direct injection injector, 112: port injection injector, 210: sensors, 220: actuators, 301: fuel spray, 302: fuel liquid film, 303: droplet, 304: tip wet, 305: unburned fuel, 500, 500A, 500B: internal combustion engine control device, 501: combustion speed detection unit, 502, 502A, 502B: internal combustion engine control device, 503: allowable value setting unit, 504: unburned fuel level adjustment unit, 510: target air-fuel ratio, 511: load information, 512: ignition time, 513: sensor signal, 514: combustion speed, 515: allowable level of unburned fuel, 516: level of unburned fuel, 520: injector, 521: fuel pump, 522: ignition coil, 523: throttle, 601: unburned fuel curve, 701: EGR concentration information, 801: unburned fuel curve, 901: correction information

1. An internal combustion engine control device to control an internal combustion engine having a fuel injection device to inject fuel, comprising:
a combustion speed detection unit to detect a combustion speed in a cylinder;
an unburned fuel level estimation unit to estimate a level of the unburned fuel in the cylinder using the combustion speed;
an allowable value setting unit to set an allowable value for the level of the unburned fuel based on an operating condition or an actual fuel injection quantity; and
an unburned fuel level adjustment unit to control the internal combustion engine so that the level of the unburned fuel estimated by the unburned fuel level estimation unit becomes lower than or equal to the allowable value.

2. The internal combustion engine control device according to claim 1,
wherein the unburned fuel level estimation unit is supplied with at least information such as a combustion speed, an ignition timing, a load on the internal combustion engine, and a target air-fuel ratio.

3. The internal combustion engine control device according to claim 2,
wherein the unburned fuel level estimation unit is further supplied with information on a concentration of the recirculated exhaust gas in the cylinder, and
wherein the unburned fuel level estimation unit corrects an estimation result of the level of the unburned fuel according to the concentration of the recirculated exhaust gas.

4. The internal combustion engine control device according to claim 2,
wherein the unburned fuel level estimation unit is further supplied with information on a compression ratio of the internal combustion engine, and
wherein the unburned fuel level estimation unit corrects an estimation result of the level of the unburned fuel according to the compression ratio.

5. The internal combustion engine control device according to claim 2,
wherein the unburned fuel level estimation unit is further supplied with information on an intake temperature or an outside air temperature; and
wherein the unburned fuel level estimation unit corrects an estimation result of the level of the unburned fuel according to the intake temperature or the outside air temperature.

6. The internal combustion engine control device according to claim 1,
wherein the unburned fuel level estimation unit includes a storage unit to store map information that associates the combustion speed with the level of the unburned fuel.

7. The internal combustion engine control device according to claim 2,
wherein the unburned fuel level estimation unit estimates the level of the unburned fuel by checking a combustion speed detected by the combustion speed detection unit against the ignition timing, the load on the internal combustion engine, and information showing the relationship between the combustion speed previously set based on the target air-fuel ratio and the level of unburned fuel.

8. The internal combustion engine control device according to claim 1,
wherein the combustion speed detection unit is supplied with at least information such as an ignition timing, a load on the internal combustion engine, a target air-fuel ratio, and a detection result from a crank angle sensor.

9. The internal combustion engine control device according to claim 1,
wherein an allowable value for the level of the unburned fuel is set by using a target air-fuel ratio and a load on the internal combustion engine as the operating

10. The internal combustion engine control device according to claim 1,
wherein the allowable value for the level of the unburned fuel is set according to an average value of a fuel quantity injected from the fuel injection device within an arbitrary set time range.

11. The internal combustion engine control device according to claim 1,
wherein the unburned fuel level adjustment unit controls at least one of a fuel injection device, a fuel pump, an ignition device, and a throttle so that the level of the unburned fuel becomes lower than or equal to the allowable value.

12. The internal combustion engine control device according to claim 1,
wherein the internal combustion engine includes a plurality of cylinders, and
wherein the unburned fuel level adjustment unit controls at least one of a fuel injection device, a fuel pump, an ignition device, and a throttle so that the level of the unburned fuel for each cylinder becomes lower than or equal to the allowable value.

13. An internal combustion engine control method for an internal combustion engine control device that controls an internal combustion engine having a fuel injection device to inject fuel, comprising:
a process to detect a combustion speed in a cylinder;
a process to estimate a level of the unburned fuel in the cylinder by using the combustion speed;
a process to set an allowable value for the level of the unburned fuel from an operating condition or an actual fuel injection quantity; and
a process to control the internal combustion engine so that the estimated level of the unburned fuel becomes lower than or equal to the allowable value.
